(19) United States
(12) Patent Application Publication
(10) Pub. No.: US 2024/0239631 A1
(43) Pub. Date: Jul. 18, 2024

(54) SHEET DISCHARGE DEVICE, AND SHEET POSTPROCESSING DEVICE, IMAGE FORMING APPARATUS, PLUS IMAGE FORMING SYSTEM EACH INCLUDING THE SHEET DISCHARGE DEVICE

(71) Applicant: KYOCERA Document Solutions Inc., Osaka (JP)

(72) Inventors: Terumitsu NOSO, Osaka (JP); Keisuke EGAWA, Osaka (JP); Yasunori UENO, Osaka (JP); Seiichi SHIRASAKI, Osaka (JP); Takehiko OKADA, Osaka (JP); Yusuke TAKANO, Osaka (JP); Takuya NISHIMURA, Osaka (JP)

(73) Assignee: KYOCERA Document Solutions Inc., Osaka (JP)

(21) Appl. No.: 18/409,451

(22) Filed: Jan. 10, 2024

(30) Foreign Application Priority Data
Jan. 18, 2023 (JP) 2023-005576

(51) Int. Cl. B65H 31/26; B41J 13/00; B41J 13/03

(52) U.S. Cl. CPC B65H 31/26; B41J 13/0036; B41J 13/03; B65H 2301/51256; B65H 2406/10

(57) ABSTRACT

The sheet discharge device includes a sheet discharge port, a discharge member, a sheet discharge tray, and a blower mechanism. The sheets discharged through the sheet discharge port by the discharge member are stacked on the sheet discharge tray. The blower mechanism includes an air blow hole for blowing off an air flow from upward to the sheets discharged through the sheet discharge port, and a blower device coupled to the air blow hole to generate the air flow. The air blow hole, being provided upward of the sheet discharge port, is placed in at least one pair or more on both sides of a center of the sheet in its widthwise direction perpendicular to the discharge direction, and the air flow derived from the air blow hole is blown off diagonally downward from outside to inside of the widthwise direction.

### INCORPORATION BY REFERENCE

This application is based on and claims the benefit of priority from Japanese Patent Application No. 2023-005576 filed on Jan. 18, 2023, the contents of which are hereby incorporated by reference.

### BACKGROUND

The present disclosure relates to a sheet discharge device for discharging sheets that have been subjected to image formation by an image forming apparatus, and also relates to a sheet postprocessing device, an image forming apparatus, and an image forming system each including the sheet discharge device.

An image forming apparatus such as copiers and printers, or a sheet postprocessing device for performing postprocessing on sheets, includes a sheet discharge device equipped with a discharge roller pair and a discharge tray. Sheets (paper) subjected to image formation by an image forming apparatus are discharged onto a discharge tray by the sheet discharge device provided in the image forming apparatus. Otherwise, the sheets, after carried into the sheet postprocessing device and subjected to specified postprocessing, are discharged onto the discharge tray by the sheet discharge device provided in the sheet postprocessing device.

With such a sheet discharge device shown above, in discharging a largely curling sheet, there has been a fear that the curling sheet as it is would block a sheet discharge port, leading to occurrence of a sheet discharge failure. Accordingly, there has been adopted a means for stabilizing sheet discharge with air blows given by a fan from upward of the sheet discharge port.

### SUMMAY

A sheet discharge device according to one aspect of the present disclosure includes a sheet discharge port, a discharge member, a sheet discharge tray, and a blower mechanism. The sheet discharge port allows sheets to be discharged therethrough. The discharge member, which is placed at the sheet discharge port, conveys sheets in a discharge direction. The sheet discharge tray is placed on a downstream side of the sheet discharge port in the discharge direction, and the sheets discharged through the sheet discharge port are stacked on the sheet discharge tray. The blower mechanism blows off an air flow against the sheets discharged through the sheet discharge port. The blower mechanism includes an air blow hole for blowing off an air flow from upward against the sheets discharged through the sheet discharge port, and a blower device coupled to the air blow hole to generate the air flow. The air blow hole, being provided upward of the sheet discharge port, is placed in at least one pair or more on both sides of a center of the sheets in a widthwise direction perpendicular to the discharge direction, and the air flow derived from the air blow hole is blown off against the sheets diagonally downward from outside to inside of the widthwise direction.

### BRIEF DESCRIPTION OF THE DRAWINGS

FIG. 1 is a schematic view showing a configuration of an image forming system which consists of a sheet postprocessing device according to one embodiment of the present disclosure, and an image forming apparatus to which the sheet postprocessing device is coupled;

FIG. 2 is a side sectional view schematically showing a configuration of the sheet postprocessing device according to the embodiment;

FIG. 3 is a perspective view of around a first sheet discharge part in the sheet postprocessing device of the embodiment;

FIG. 4 is a side sectional view of around the first sheet discharge part in the sheet postprocessing device of the embodiment;

FIG. 5 is a perspective view showing an aspect in which sheets are discharged to the first sheet discharge part, as viewed from upward; and

FIG. 6 is a view of a modification example of the first sheet discharge part in which two pairs of air blow holes are placed on both sides of a sheet widthwise direction.

### DETAILED DESCRIPTION

### 1. Configuration of Image Forming System

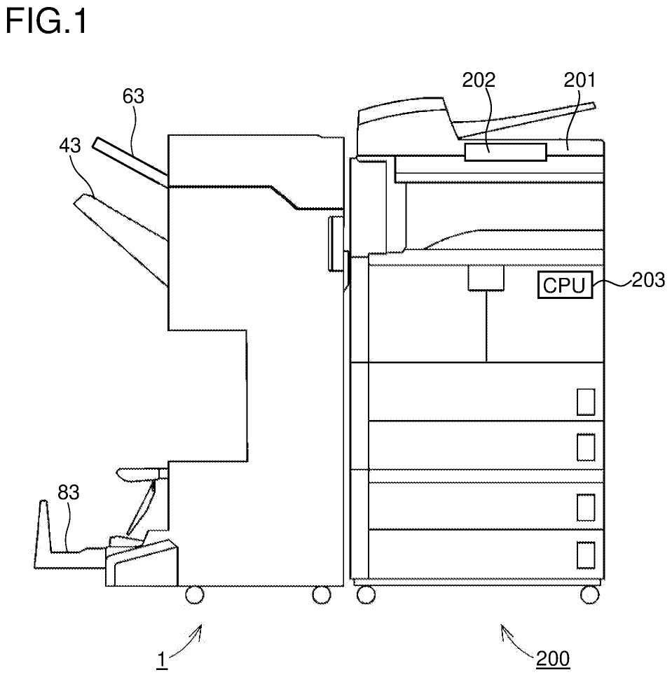

Hereinafter, an embodiment of the present disclosure will be described in detail with reference to the accompanying drawings. FIG. 1 is a schematic view showing a configuration of an image forming system which consists of a sheet postprocessing device 1 according to one embodiment of the disclosure, and an image forming apparatus 200 to which the sheet postprocessing device 1 is coupled.

As shown in FIG. 1, the image forming apparatus 200 prints out an image on a sheet (paper) on a basis of image data inputted from external via an unshown network communication part or image data read by an image reading part 201 placed on top of the image forming apparatus 200. In this embodiment, the image forming apparatus 200 is an inkjet recording apparatus which includes recording heads (not shown) provided on an each-color basis and equipped with a multiplicity of nozzle holes through which ink is jetted out onto a sheet.

An operation panel 202 is placed forward of the image reading part 201. The operation panel 202 is an operation part for accepting various types of setting inputs. For example, a user is enabled to enter sheet-size information by operating the operation panel 202. Also by operating the operation panel 202, the user is allowed to enter a number of sheets to be printed and to instruct for a start of a print job. A main body controller 203 administers overall operations of the image forming apparatus 200 and controls individual parts of the image forming apparatus 200.

The sheet postprocessing device 1 is removably coupled to a side face of the image forming apparatus 200. The sheet postprocessing device 1 performs such postprocessing as a punch-hole forming process and a stapling process on a sheet having been subjected to image formation (printing) by the image forming apparatus 200. It is noted that the sheet postprocessing device 1 is not limited to one which performs postprocessing on a sheet automatically conveyed from the image forming apparatus 200, and may be one which allows a user to set a sheet on an unshown tray, the sheet then being conveyed up to a postprocessing-enabled position by the device itself and subjected to postprocessing.

### 2. Configuration of Sheet Postprocessing Device

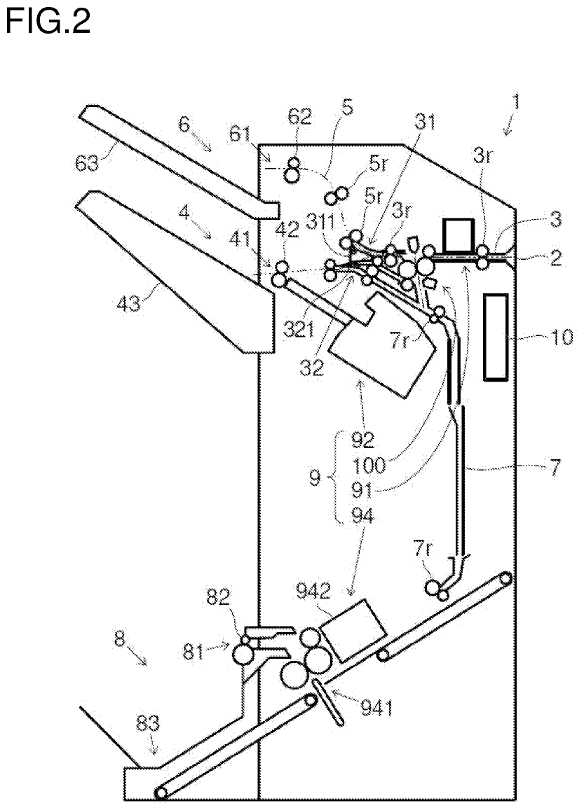

FIG. 2 is a side sectional view schematically showing a configuration of the sheet postprocessing device 1 in this embodiment. The sheet postprocessing device 1, as shown in FIG. 2, includes a sheet inlet 2, a first sheet conveyance path 3, a first sheet discharge part 4, a second sheet conveyance path 5, a second sheet discharge part 6, a third sheet conveyance path 7, a third sheet discharge part 8, a postprocessing part 9, and a postprocessing controller (controller) 10.

The sheet inlet 2 is an opening provided in a side face of the sheet postprocessing device 1 facing the image forming apparatus 200. A sheet conveyed from the image forming apparatus 200 toward the sheet postprocessing device 1 is conveyed through the sheet inlet 2 so as to be carried into the sheet postprocessing device 1.

The first sheet conveyance path 3 extends from the sheet inlet 2 to the first sheet discharge part 4 in such a generally horizontal direction (leftward direction in FIG. 2) as to become farther from the image forming apparatus 200. It is noted that a direction from the sheet inlet 2 toward the first sheet discharge part 4 is referred to as a sheet conveyance direction of the first sheet conveyance path 3. The sheet inlet 2 is located at an upstream end of the first sheet conveyance path 3 in the sheet conveyance direction. The first sheet conveyance path 3, having thereon a plurality of conveyance roller pairs 3r, conveys a sheet, which has been delivered through the sheet inlet 2 into the sheet postprocessing device 1, toward a downstream side in the sheet conveyance direction.

The first sheet discharge part 4 is provided on a side face of the sheet postprocessing device 1 opposite to its side face facing the image forming apparatus 200. The first sheet discharge part 4 is placed at a downstream end of the first sheet conveyance path 3 in the sheet conveyance direction. The first sheet discharge part 4 includes a first discharge port 41, a first discharge roller pair 42, and a first discharge tray 43.

The first discharge port 41 is located at a downstream end of the first sheet conveyance path 3 in the sheet conveyance direction. The first discharge roller pair 42 is placed at the first discharge port 41. The first discharge tray 43 is located downstream of the first discharge port 41 in the sheet conveyance direction. A sheet conveyed along the first sheet conveyance path 3 and having reached the first discharge port 41 is passed through the first discharge port 41 and discharged onto the first discharge tray 43 by the first discharge roller pair 42. The first discharge tray 43 is one of terminal discharge places for sheets subjected to postprocessing by the sheet postprocessing device 1.

The second sheet conveyance path 5, branching from a first branch portion (branch portion) 31 on the first sheet conveyance path 3, extends up to the second sheet discharge part 6 laterally and upwardly in such a direction as to become farther from the image forming apparatus 200 (leftward direction in FIG. 2). The first branch portion 31 is placed downstream of a punching portion 91 in the first sheet conveyance path 3 in the sheet conveyance direction. It is noted that a direction directed from the first branch portion 31 toward the second sheet discharge part 6 is referred to as a sheet conveyance direction of the second sheet conveyance path 5. The first branch portion 31 is located at an upstream end of the second sheet conveyance path 5 in the sheet conveyance direction. The second sheet conveyance path 5, having a plurality of conveyance roller pairs 5r, leads a sheet, which is under conveyance on the first sheet conveyance path 3, such that the sheet branches at the first branch portion 31 so as to be conveyed toward the second sheet discharge part 6.

The first branch portion 31 includes a first switching guide 311. The first switching guide 311 pivotally turns between a position in which a sheet conveyed on the first sheet conveyance path 3 from the sheet inlet 2 side is guided along the first sheet conveyance path 3 to the first discharge port 41, and another position in which the sheet is made to branch from the first sheet conveyance path 3 so as to be guided to the second sheet conveyance path 5. The first switching guide 311 further pivotally turns to yet another position in which a sheet subjected to a folding process and having passed through a later-described second folding conveyance path 106 is guided to the second sheet conveyance path 5. The first switching guide 311 is connected to a drive mechanism (not shown) and controlled in its operation by the postprocessing controller 10.

The second sheet discharge part 6 is provided upward of the first sheet discharge part 4 and on the side face of the sheet postprocessing device 1 opposite to its side face facing the image forming apparatus 200. The second sheet discharge part 6 is placed at a downstream end of the second sheet conveyance path 5 in the sheet conveyance direction. The second sheet discharge part 6 includes a second discharge port 61, a second discharge roller pair 62, and a second discharge tray 63.

The second discharge port 61 is located at a downstream end of the second sheet conveyance path 5 in the sheet conveyance direction. The second discharge roller pair 62 is placed at the second discharge port 61. The second discharge tray 63 is located downstream of the second discharge port 61 in the sheet conveyance direction. A sheet conveyed along the second sheet conveyance path 5 and having reached the second discharge port 61 is passed through the second discharge port 61 and discharged onto the second discharge tray 63 by the second discharge roller pair 62. The second discharge tray 63 is one of the terminal discharge places for sheets subjected to postprocessing by the sheet postprocessing device 1. In addition, such sheets as those destined for no postprocessing and those of smaller sizes are also discharged onto the second discharge tray 63.

The third sheet conveyance path 7, branching from a second branch portion 32 on the first sheet conveyance path 3, extends downward to the third sheet discharge part 8. It is noted that a direction directed from the second branch portion 32 toward the third sheet discharge part 8 is referred to as a sheet conveyance direction of the third sheet conveyance path 7. The second branch portion 32 is located on a downstream side of the first branch portion 31 in the sheet conveyance direction of the first sheet conveyance path 3, and moreover located at an upstream end of the third sheet conveyance path 7 in the sheet conveyance direction. The third sheet conveyance path 7, having a plurality of conveyance roller pairs 7r, leads a sheet, which is under conveyance on the first sheet conveyance path 3, such that the sheet is made to branch at the second branch portion 32 and conveyed toward the third sheet discharge part 8.

The second branch portion 32 includes a second switching guide 321. The second switching guide 321 pivotally turns between a position in which a sheet conveyed on the first sheet conveyance path 3 from the sheet inlet 2 side is guided along the first sheet conveyance path 3 to the first discharge port 41, and another position in which a sheet, which is switched back after conveyance on the first sheet conveyance path 3 from the sheet inlet 2 side and passage through the second branch portion 32, is led to the third sheet conveyance path 7. The second switching guide 321 is connected to a drive mechanism (not shown) and controlled in its operation by the postprocessing controller 10.

The third sheet discharge part 8 is provided downward of the first sheet discharge part 4 (near a lower end portion of the sheet postprocessing device 1) and on the side face of the sheet postprocessing device 1 opposite to its side face facing the image forming apparatus 200. The third sheet discharge part 8 includes a third discharge port 81, a third discharge roller pair 82, and a third discharge tray 83.

The third discharge port 81 is located at a downstream end of the third sheet conveyance path 7 in the sheet conveyance direction. The third discharge roller pair 82 is placed at the third discharge port 81. The third discharge tray 83 is located downstream of the third discharge port 81 in the sheet conveyance direction. A sheet conveyed on the third sheet conveyance path 7 and having reached the third discharge port 81 is passed through the third discharge port 81 and discharged onto the third discharge tray 83 by the third discharge roller pair 82. The third discharge tray 83 is one of the terminal discharge places for sheets subjected to postprocessing by the sheet postprocessing device 1.

The postprocessing part 9 performs specified postprocessing on a sheet subjected to image formation by the image forming apparatus 200 and carried into the sheet postprocessing device 1. The postprocessing part 9 includes the punching portion 91, a sheet stapling unit 92, a sheet folding unit 100, and a bookbinding portion 94.

The punching portion 91 is placed in downstream-side close vicinity of the sheet inlet 2 in the first sheet conveyance path 3. The punching portion 91 performs a punching process on a sheet conveyed on the first sheet conveyance path 3, making a punch hole or holes formed thereon.

The sheet stapling unit 92 is placed in upstream-side close vicinity of the first sheet discharge part 4 as viewed in the sheet conveyance direction of the first sheet conveyance path 3. The sheet stapling unit 92 performs a stapling process on a sheet bundle formed by stacking a plurality of sheets, so that the sheet bundle is stapled. A detailed configuration of the sheet stapling unit 92 will be described later.

The sheet folding unit 100 is placed downstream of the punching portion 91 and upstream of the sheet stapling unit 92, as viewed in the sheet conveyance direction of the first sheet conveyance path 3. The sheet folding unit 100 performs a folding process on one sheet to form a fold or folds thereon. The sheet folding unit 100 is enabled to perform, for one sheet, such folding processes as two-folding, Z-folding, outward three-folding, and inward three-folding.

The bookbinding portion 94 is placed in upstream-side close vicinity of the third sheet discharge part 8 as viewed in the sheet conveyance direction of the third sheet conveyance path 7. The bookbinding portion 94 includes a middle-folding part 941, and a saddle-stitching part 942. The bookbinding portion 94 performs, on a sheet bundle formed by stacking a plurality of sheets, a middle-folding process and a saddle-stitching process for folding and stitching a generally central portion of the sheet bundle in the sheet conveyance direction to make up a booklet.

The postprocessing controller (controller) 10 includes a CPU, a storage part, and other electronic circuits and electronic components (none shown). The postprocessing controller 10 is communicably connected to the main body controller 203 of the image forming apparatus 200 (see FIG. 1). The postprocessing controller 10, receiving a command from the main body controller 203, controls operations of individual components provided in the sheet postprocessing device 1 on a basis of control programs and data stored in the storage part with use of the CPU, thereby fulfilling processes related to functions of the sheet postprocessing device 1. The first sheet conveyance path 3, the first sheet discharge part 4, the second sheet conveyance path 5, the second sheet discharge part 6, the third sheet conveyance path 7, the third sheet discharge part 8, and the postprocessing part 9 individually receiving commands from the postprocessing controller 10, perform postprocessing on a sheet in linkage with one another. In addition, instead, the functions of the postprocessing controller 10 may also be fulfilled by the main body controller 203 of the image forming apparatus 200 in addition to its inherent functions.

### 3. Configuration of First Sheet Discharge Part

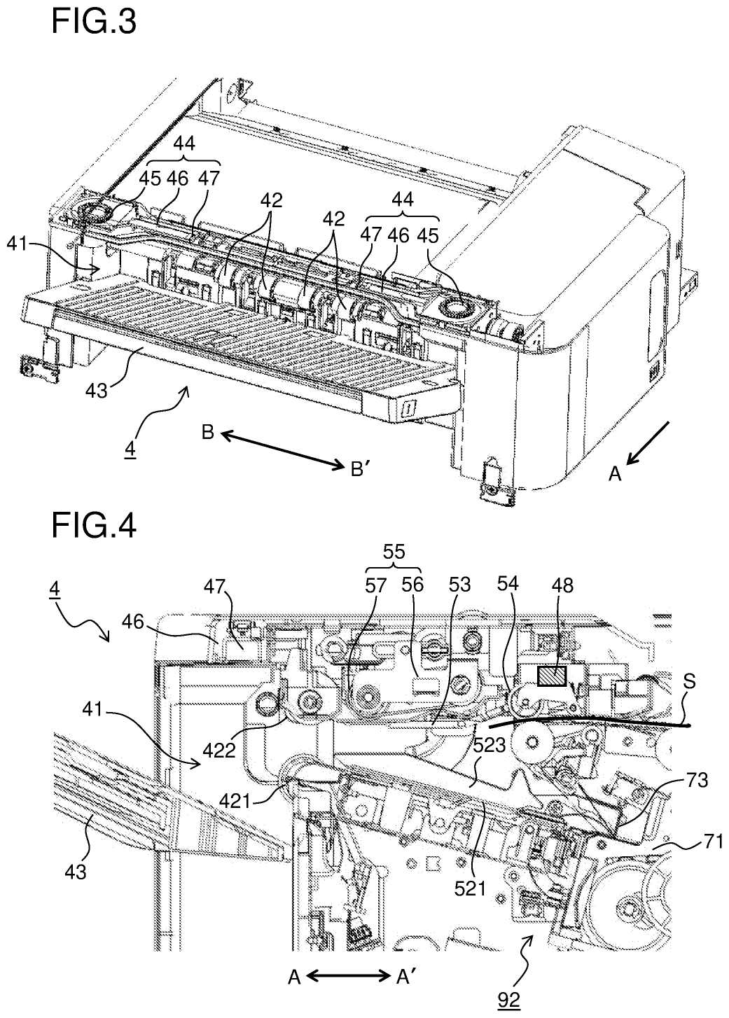

Next, a configuration of around the first sheet discharge part 4 is described. FIG. 3 is a perspective view of around the first sheet discharge part 4. As shown in FIG. 3, the first sheet discharge part 4 (sheet discharge device) includes a blower mechanism 44 in addition to the first discharge port 41, the first discharge roller pair 42 and the first discharge tray 43 which are described before. The blower mechanism 44 includes a blower device 45, an air flow duct 46, and an air blow hole 47.

The blower device 45 is placed, upward of the first discharge port 41, in one pair on both sides of a sheet widthwise direction (arrow B-B′ direction) perpendicular to a sheet discharge direction (arrow A direction). In more detail, each blower device 45 is placed outside of a sheet width of a maximum-size sheet discharged onto the first discharge tray 43 in the sheet widthwise direction. In this embodiment, a sirocco fan is used as the blower device 45.

The air flow duct 46 is placed in one pair each inside of the pair of blower devices 45 in the sheet widthwise direction. The pair of air flow ducts 46 extend in the sheet widthwise direction along upper portions, respectively, of the first discharge port 41. One end portion (outer-side end portion in the sheet widthwise direction) of each air flow duct 46 is coupled to a blowoff opening of the blower device 45. The air blow hole 47 is formed on the other end portion (inner-side end portion in the sheet widthwise direction) of each air flow duct 46.

FIG. 4 is a side sectional view of around the first sheet discharge part 4. As shown in FIG. 4, the sheet stapling unit 92 is placed on an upstream side (right side in FIG. 4) of the first sheet discharge part 4 in the sheet discharge direction (arrow A direction). The sheet stapling unit 92 includes a processing tray 521, a stapling part 71, and reference plates 73.

The processing tray 521 is a rectangular-shaped tray extending in the sheet discharge direction (arrow A direction) as well as in the sheet widthwise direction (arrow B-B′ direction). A plurality of sheets (sheet bundle) to be subjected to the stapling process are stacked on the processing tray 521. Each sheet S is carried onto the processing tray 521 by the carry-in roller pair 54 in the same direction (carry-in direction, arrow A direction) as the discharge direction. The sheet bundle subjected to the stapling process is sent out by the first discharge roller pair 42 in the sheet discharge direction so as to be discharged onto the first discharge tray 43.

The processing tray 521 includes a width-restricting member 523. The width-restricting member 523 is placed in one pair in the sheet widthwise direction. Each width-restricting member 523 is enabled to reciprocate in the sheet widthwise direction along a top face of the processing tray 521 via a drive mechanism (not shown) such as a rack-and-pinion gear. In this embodiment, each time a sheet S is carried onto the processing tray 521, the width-restricting members 523 are reciprocatively moved by the drive mechanism. As a result, sheets S carried onto the processing tray 521 are aligned in terms of position in the sheet widthwise direction.

The stapling part 71 is placed in opposition to a downstream-side (right side in FIG. 4) end edge of the sheet S in an alignment direction (arrow A′ direction) opposite to the carry-in direction of the sheet S. The stapling part 71, being movable along the end edge of the sheet in the sheet widthwise direction (arrow B-B′ direction) by driving force of a motor (not shown), performs the stapling process on a bundle of sheets S.

The reference plates 73 are fixed at the processing tray 521 so as to be opposed to a downstream-side (right side in FIG. 4) end portion of the processing tray 521, in the alignment direction. Each reference plate 73 is generally U-shaped with its alignment-direction upstream side (left side in FIG. 4) opened, in a cross section perpendicular to the sheet widthwise direction. The reference plate 73 makes contact with the end edge of the sheet carried onto the processing tray 521 so as to align the sheet in the alignment direction (arrow A′ direction).

The carry-in roller pair 54 is placed upward of the processing tray 521. A sheet detection sensor 48 is placed in vicinity of the carry-in roller pair 54. The sheet detection sensor 48 detects a timing at which the sheet S has passed through the carry-in roller pair 54. As the sheet detection sensor 48, a PI (photointerrupter) sensor including a detector part composed of a light-emitting part and a light-receiving part is used as an example.

A tapping member 53 and an alignment member 55 are provided on a downstream side (left side in FIG. 4) of the carry-in roller pair 54 as viewed in the carry-in direction of the sheet S. The tapping member 53 is swingably supported along the carry-in direction of the sheet S. The tapping member 53 swings downward at a timing when a rear end of the sheet S has passed through the carry-in roller pair 54, so that the sheet S is tapped downward so as to be aligned along the processing tray 521.

The alignment member 55 is placed at a plurality of places (four places in this embodiment) along the sheet widthwise direction (a direction perpendicular to the drawing sheet of FIG. 4). The alignment member 55 makes the sheet S, which is about to be carried onto the processing tray 521, moved (switched back) in such an alignment direction that the sheet S gets nearer to the reference plates 73, thus giving aid for sheet S alignment. The alignment member 55 includes a paddle holder 56 and an alignment paddle 57.

The paddle holder 56 is swingably supported along the carry-in direction of the sheet S. Rotation driving force is inputted to a swinging shaft of the paddle holder 56 by a paddle driving motor (not shown). Inputted to the alignment paddle 57 by a drive source (not shown) such as a motor is rotation driving force in such a direction (counterclockwise direction in FIG. 4) as to send out the sheet S in the alignment direction. As the alignment paddle 57 is rotated in contact with a top face of the sheet S that is carried onto the processing tray 521, the sheet S is moved in an alignment direction so that end edges of the sheet S are thrust against the reference plates 73, thus the sheet S being aligned.

Swings of the paddle holder 56 are controlled based on a detection timing of the sheet detection sensor 48. More specifically, at a timing when the sheet detection sensor 48 detects that the fore end of the sheet S has passed through the carry-in roller pair 54, the paddle holder 56 is swung upward. As a result, the alignment paddle 57 is separated apart from the top face of the processing tray 521 (or of the sheets S stacked on the processing tray 521).

FIG. 4 shows a state immediately before a new sheet S is carried onto the processing tray 521, in which state the paddle holder 56 swings upward (in a clockwise direction) and the alignment paddle 57 is placed at a position (reference position) separate from the processing tray 521. Also, the discharge lower roller 421 and a discharge upper roller 422, both of which compose the first discharge roller pair 42, are released from their nip. As a result of this, the sheet S carried from the carry-in roller pair 54 onto the processing tray 521 once passes through the first discharge roller pair 42 so as to be projected above the first discharge tray 43.

Then, after an end edge of the new sheet S carried onto the processing tray 521 is tapped by the tapping member 53 so as to be aligned along the processing tray 521, the paddle holder 56 is swung to a specified extent in the reverse direction (counterclockwise direction). As a result of this, the alignment paddle 57 is placed at such a position (acting position) as to make contact with the top face of the sheet S. In this state, the alignment paddle 57 is turned, causing the sheet S to be pulled in the alignment direction (arrow A′ direction) along the processing tray 521. Repeating the above-described operation each time a sheet S is carried in makes it possible to securely put the alignment paddle 57 into contact with the top face of the sheet while avoiding interference between the fore end of the sheet S carried onto the processing tray 521 and the alignment paddle 57.

Thereafter, the sheet S is conveyed further to a downstream side in the alignment direction by the alignment paddle 57, aligned in the sheet widthwise direction by the width-restricting members 523, and aligned and loaded in the carry-in direction by the reference plates 73.

Then, after the stapling part 71 has been moved to a specified stapling position, the postprocessing controller 10 transmits a control signal to the stapling part 71 so as to make the stapling process executed on a plurality of sheets S aligned by the reference plates 73. The postprocessing controller 10 makes the first discharge roller pair 42 put into mutual contact (nip formation) and moreover rotated in the discharge direction. As a result of this, a bundle of sheets S subjected to the stapling process is discharged onto the first discharge tray 43 by the first discharge roller pair 42.

### 5. Sheet Discharge Aid Operation for First Discharge Tray by Blower Mechanism

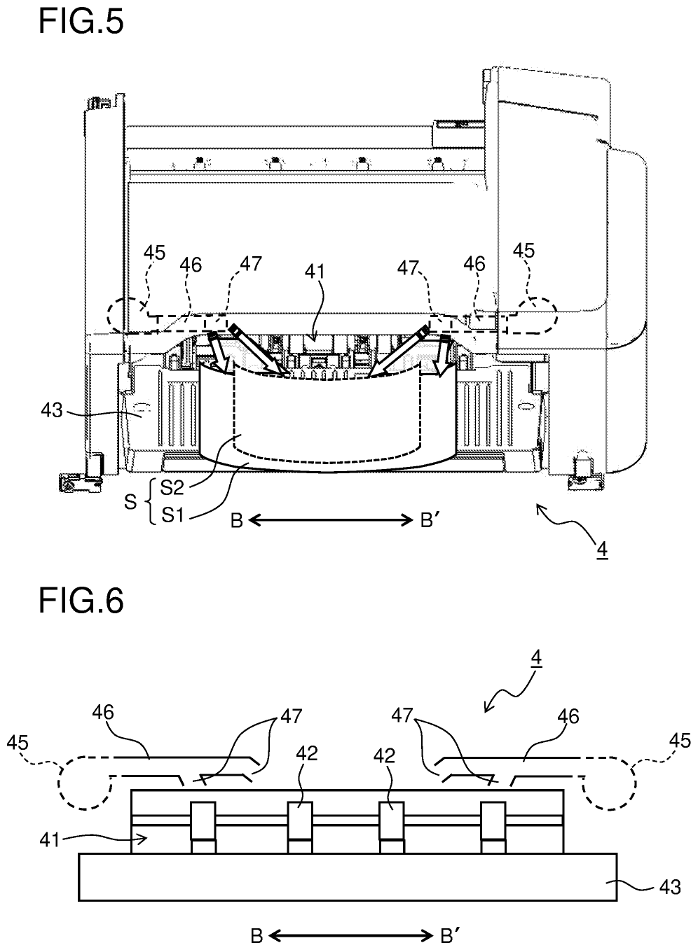

Next, a sheet discharge assist operation for the first discharge tray 43 by the blower mechanism 44 is described. FIG. 5 is a perspective view showing an aspect in which sheets S are discharged to the first sheet discharge part 4, as viewed from upward. As indicated by unfilled arrows in FIG. 5, an air flow generated by the blower device 45, passing through the air flow duct 46, being blown from the air blow hole 47 downward toward the sheets S that are to be discharged onto the first discharge tray 43.

In more detail, each blower mechanism 44 blows off an air flow diagonally downward from outside to inside, in the widthwise direction of the sheet S, from a pair of air blow holes 47 provided on both sides of a widthwise center of the sheets S. The blower mechanism 44 blows off an air flow against widthwise inner-side regions of the sheets S, the regions being inside of side end edges of a maximum-size sheet S discharged through the first discharge port 41.

According to the above-described configuration, curling at the rear end of a largely curlable sheet S can be suppressed with air flows, so that stackability and dischargeability of the sheet S to the first discharge tray 43 can be ensured. In particular, when the image forming apparatus 200 coupled to the sheet postprocessing device 1 is an inkjet recording apparatus as in this embodiment, curls of the sheet S to be discharged tend to become larger. However, even in such cases, the sheet S can be stably discharged and loaded.

Also, the blower mechanism 44 performs air blowing from outside to inside of the sheet widthwise direction against widthwise inner-side regions of the sheet S, the regions being inside of side end edges of a maximum-size sheet S discharged through the first discharge port 41. As a result of this, an air flow can be securely blown off against the rear end of a large-size sheet S1 or a small-size sheet S2. Therefore, curls can be effectively suppressed irrespectively of sheet size.

Also in this embodiment, air blowing by the blower mechanism 44 is kept halted until the fore end of the sheet S discharged by the first discharge roller pair 42 comes into contact with the first discharge tray 43 (or sheets S stacked on the first discharge tray 43). Then, at a timing or later when the fore end of the sheet S has come into contact with the first discharge tray 43 (or sheets S stacked on the first discharge tray 43), air blowing by the blower mechanism 44 is started.

More specifically, when a detection timing (detection signal) as to detection of the fore end of the sheet S is transmitted from the sheet detection sensor 48 (see FIG. 4), the postprocessing controller 10 decides whether or not a specified time T has elapsed since the detection timing. When the specified time T has elapsed, the postprocessing controller 10 decides that the fore end of the sheet S has come into contact with the first discharge tray 43 (or sheets S stacked on the first discharge tray 43), then transmitting a control signal to the blower device 45 to start air blowing. The specified time T is calculated based on discharge speed of the sheet S.

By starting air blowing at the above-described timing, it becomes implementable to below off an air flow concentratedly on the highly-curlable rear end of the sheet S in the discharge direction, while suppressing flaps of the fore end of the sheet S in the discharge direction due to air blowing. As a consequence of this, the sheet S can be stably discharged from the first discharge port 41, and moreover the sheet S can be stacked on the first discharge tray 43 while curls of the rear end of the sheet S are effectively suppressed.

Although an embodiment of the present disclosure has been described hereinabove, yet the scope of the disclosure is not limited to this, and the disclosure may be changed and modified in various ways unless those changes and modifications depart from the gist of the invention. For example, although the air blow holes 47 through which an air flow from the blower device 45 is blown off are placed in one pair on both sides of the sheet widthwise direction in the embodiment, it is also allowable that with the air flow duct 46 formed into branches as shown in FIG. 6 as an example, the air blow holes 47 are placed in two pairs on both sides of the sheet widthwise direction.

With a configuration as shown in FIG. 6, even when sheets S to be stacked on the processing tray 521 considerably differ in their widthwise size, an air flow can be securely blown off to the rear end of the sheets S. The air blow holes 47 may also be placed in three or more pairs on both sides of the sheet widthwise direction.

Further, although the blower device 45 and the air blow hole 47 are coupled to each other via the air flow duct 46 in the above embodiment, it is also allowable that without providing the air flow duct 46, the blower device 45 is set in a tilted state so as to couple the blower device 45 and the air blow hole 47 directly to each other.

Also in the above embodiment, the sheet discharge device of the disclosure is exemplified by the first sheet discharge part 4 from which sheets S stacked on the processing tray 521 and subjected to the stapling process by the sheet stapling unit 92 are discharged. However, without being limited to this, the present disclosure may also be applied to the second sheet discharge part 6.

Also in the above embodiment, the image forming apparatus 200 is exemplified by an inkjet recording apparatus. However, electrophotographic printers and copiers are also usable as the image forming apparatus 200. In this connection, in the inkjet recording system in which ink is jetted out onto a sheet, the sheet is more likely to curl as compared to the electrophotographic system. As a consequence, the present disclosure is particularly useful for the sheet postprocessing device 1 to which an inkjet recording apparatus is coupled as the image forming apparatus 200.

Also in the above embodiment, the sheet discharge device of the disclosure is exemplified by the first sheet discharge part 4 of the sheet postprocessing device 1 coupled to the image forming apparatus 200. However, the sheet discharge device of the disclosure may be applied also to the sheet discharge part of the image forming apparatus 200 that is used without being coupled to the sheet postprocessing device 1.

The present disclosure is applicable to a sheet discharge device for discharging sheets, as well as sheet postprocessing devices, image forming apparatuses, and image forming systems each including the sheet discharge device.

What is claimed is:

1. A sheet discharge device comprising:
a sheet discharge port which allows sheets to be discharged therethrough;
a discharge member which is placed at the sheet discharge port and which conveys the sheets in a discharge direction;
a sheet discharge tray which is placed on a downstream side of the sheet discharge port in the discharge direction and on which the sheets discharged through the sheet discharge port are stacked; and
a blower mechanism for blowing off an air flow to the sheets discharged through the sheet discharge port, wherein
the blower mechanism includes:
an air blow hole for blowing off an air flow from upward against the sheets discharged through the sheet discharge port; and
a blower device coupled to the air blow hole to generate the air flow, and
the air blow hole, being provided upward of the sheet discharge port, is placed in at least one pair or more on both sides of a center of the sheet in a widthwise direction perpendicular to the discharge direction, and the air flow derived from the air blow hole is blown off against the sheets diagonally downward from outside to inside of the widthwise direction.

2. The sheet discharge device according to claim 1, further comprising
a controller for controlling the blower device, wherein
the controller
starts blowoff of the air flow by the blower device at a timing or later when a fore end of the sheet has come into contact with the sheet discharge tray or the sheets stacked on the sheet discharge tray.

3. The sheet discharge device according to claim 1, wherein
with the air blow hole placed in one pair, the blower mechanism blows off the air flow against widthwise inner-side regions of the sheets, the regions being inside of side end edges of a maximum-size sheet discharged through the sheet discharge port.

4. The sheet discharge device according to claim 1, wherein
the air blow hole is placed in plural pairs on both sides of a center in the widthwise direction.

5. A sheet postprocessing device comprising:
a postprocessing part for performing specified postprocessing on a sheet; and
the sheet discharge device according to claim 1 for discharging the sheet subjected to postprocessing by the postprocessing part.

6. An image forming system comprising:
an image forming apparatus for forming an image on a sheet; and
the sheet postprocessing device according to claim 5 for performing specified postprocessing on the sheet subjected to image formation by the image forming apparatus.

7. The image forming system according to claim 6, wherein
the image forming apparatus is an inkjet recording apparatus for performing image recording by jetting out ink onto the sheet.

8. An image forming apparatus comprising:
an image forming part for forming an image on a sheet; and
the sheet discharge device according to claim 1 for discharging the sheet subjected to image formation by the image forming part.

9. The image forming apparatus according to claim 8, wherein
the image forming part performs image recording by jetting out ink onto the sheet.
